(19) United States
(12) Patent Application Publication
(10) Pub. No.: US 2025/0348365 A1
(43) Pub. Date: Nov. 13, 2025

(54) DISAGGREGATED LOAD BALANCER

(71) Applicant: Microsoft Technology Licensing, LLC, Redmond, WA (US)

(72) Inventors: Mohit DEWAN, Brambleton, VA (US); Geoffrey OUTHRED, Seattle, WA (US); Jacob Eric NELSON, Seattle, WA (US); Daniel Robert Kenneth PORTS, Seattle, WA (US); Trevor Ross ADAMS, Meguro City (JP)

(21) Appl. No.: 18/657,975

(22) Filed: May 8, 2024

(51) Int. Cl. G06F 9/50

(52) U.S. Cl. CPC G06F 9/5083

(57) ABSTRACT

A method of load balancing in disaggregated load balancing system includes receiving, at a hardware accelerator, a data packet; performing a lookup-operation in a flow cache of the hardware accelerator; and transmitting the data packet from the hardware accelerator to a flow admission service executed by a software-based load balancing component in response to determining that the flow cache of the hardware accelerator does not yet include a flow entry that matches packet header information of the data packet. The method further includes receiving, from the software-based load balancing component, a new flow entry associated with the data packet that defines a first packet transformation for the data packet; updating the flow cache stored on the hardware accelerator to include the new flow entry; and processing the data packet on the hardware accelerator by applying the first packet transformation.

### BACKGROUND

Load balancing refers to efficiently distributing incoming network traffic across a group of backend servers or resources. There exist a number of different types of load balancing systems that offer differ functionality.

A first approach to load balancing is to use dedicated load balancing hardware—e.g., a special-purpose load-balancing ASIC (application-specific integrated circuit) or a special-purposed FPGA (field programmable gate array) designed, by a vendor, to perform load balancing functionality. While switch ASICs perform highly-efficient packet processing, they offer fixed throughput capacity and lack flexibility in terms of adaptability to customer-specific load balancing needs. For example, dedicated load balancing hardware may not be capable of implementing routing policies defined by the service endpoint provider.

A second approach to load balancing is to use general purpose servers to execute software-implemented load balancing logic. Compared to traditional switch ASICs, these software-based load balancers offer a high degree of flexibility in terms of customer-configurable routing logic and can service a slightly larger number of endpoints (e.g., 5 to 7 servers might service 10,000 endpoints). When load balancing is performed by a general- purpose server, a central processing unit (CPU) of the server is used to perform flow admission tasks such as evaluating routing policies and defining cach new flow, while routing tasks (e.g., flow transform operations) are offloaded to one or more smart network interface controllers (smart NICs) within the server. In general, the CPU is more capable at performing the flow admission tasks than dedicated load balancing hardware, but a smart NIC has comparatively limited port bandwidth.

To increase scalability in software-based load balancing systems, some data centers currently implement distributed load balancing logic. For example, one-hundred thousand servers utilize cache coherency protocols to jointly manage traffic flows across ˜1 million endpoints. In these systems, the limited number of smart NIC ports within each server is the primary factor that drives up-scaling demand. For example, when a smart NIC of a dedicated load balancer server is operating at max capacity, the CPU within each of these dedicated load-balancer servers is typically operating far below its respective capacity.

Still another approach to load balancing is to use a programmable switch application specific integrated circuit (“programmable switch ASIC”) that is designed look a bit like a hybrid between a field programmable gate array (FPGA) and a traditional switch ASIC. A programmable switch ASIC offers a mixture of fixed-function and reconfigurable logic, including the ability to parse and extract data from each packet processed by the switch, perform simple computations, look up data in tables, rewrite packets, and even perform stateful computations. Programmable switch ASICs give the user significant control over the set and order of operations applied to each packet, while still sharing a core high-level architecture with fixed-function switch ASICs. Compared with FPGAs and smart NICs, programmable switch ASICs provide increased port density and are therefore more efficient at executing routing functions (e.g., packet transformations) then general-purpose servers, at the cost of some flexibility and configurability. However, programmable switch ASICs are still less efficient than CPUs at performing flow admission tasks (e.g., managing large tables of existing flows) because limited computation capacity of on-chip memory makes it difficult to handle failures in a fault tolerant manner, restricting the scalability of the system.

### SUMMARY

According to one implementation, a method of packet processing in a disaggregated load balancing system includes receiving, at a hardware accelerator, a data packet in route to a domain hosted by a service provider subscribed to a load-balancing service. The method further includes performing a lookup operation in a flow cache of the hardware accelerator based on packet header information of the data packet and, in response to determining that the flow cache of the hardware accelerator does not yet include a flow entry that matches the packet header information of the data packet, transmitting the data packet from the hardware accelerator to a flow admission service executed by a software-based load balancing component. The method further includes receiving, from the software-based load balancing component, a new flow entry associated with the data packet that defines a first packet transformation for the data packet; updating the flow cache stored on the hardware accelerator to include the new flow entry; and processing the data packet on the hardware accelerator by applying the first packet transformation.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example disaggregated load balancing system implementing aspects of the disclosed technology.

FIG. 2 illustrates aspects of another example disaggregated load balancing system implementing aspects of the disclosed technology.

FIG. 3 illustrates an example distributed disaggregated load balancing system implementing additional aspects of the disclosed technology.

FIG. 4 illustrates example operations for performing packet transformations used to route data packets within a disaggregated load balancing system.

FIG. 5 illustrates an example schematic of a processing device suitable for implementing aspects of the disclosed technology.

### DETAILED DESCRIPTION

Existing load-balancing solutions force cloud platform providers to choose between software-only solutions and hardware-only solutions. Software-only solutions provide maximum flexibility in terms of policy evaluation and flow table management at the cost of inefficient packet transform operations (e.g., by smart NICs). In contrast, hardware-only solutions are optimized for high-throughput packet transform operations but are limited in terms of table management capabilities and routing policy flexibility.

The herein disclosed technology includes a hybrid load balancing system that incorporates software-implemented logic (e.g., by a CPU) and specially-purposed load balancing hardware (e.g., a programmable switch ASIC) that each respectively perform different aspects of load balancing that are traditionally implemented exclusively by either a specially-purposed switch ASIC or load-balancing server. The hybrid load balancing system is described herein as being “disaggregated” because the system disaggregates (separates) load balancing tasks into two buckets—(1) tasks that are more efficiently-performed by software and (2) tasks that are more efficiently performed by dedicated hardware. A data packet traversing an end-to-end path is subjected to some processing by a software-based load balancing component and other processing by a hardware accelerator specially-purposed for load balancing. In one implementation, the software-based load balancer leverages available memory to perform stateful load balancing decisions (e.g., flow admission) while the hardware accelerator is tasked with packet transform at multi-terabit line rate with predictable performance. The disaggregated load balancing system is more efficient (e.g., utilizes less compute power) than functionally-equivalent software-only and hardware-only load balancing systems due to its unique ability to leverage the different efficiencies of both types of systems.

In some implementations, the disaggregated load balancing system is also distributed in the sense that there exist many different instances of the hardware accelerator cach configured to interact with many different instances of the software-based load balancer in the same way. A cache coherency protocol is utilized to support a stateful software backend that allows the hardware accelerators to operate ephemerally—meaning, any hardware accelerator can go offline and return again without the system losing routing functionality due to cache coherency between the stateful software backend and each hardware accelerator. Within this framework, respective hardware and software sides of the load balancing system can be scaled independently such that servers can be added without adding hardware accelerators and vice versa. Due to this independent scalability, the on-chip memory limitations that have traditionally driven scaling in hardware-only solutions is no longer a limiting factor that increases the number of hardware-specific load balancing boxes (e.g., switch ASICS or programmable switch ASICS) in the distributed load balancing system. Likewise, the limited port availability in smart NICs that has traditionally driven scaling in software-only solutions is no longer a limiting factor that increases the number of servers within the load balancing system. Each hardware switch can instead be driven to at or near its respective port capacity (which is much higher than a general-purpose server) and cach server can be driven to at or near its respective memory capacity (which is much higher than the available memory on each hardware switch).

Ultimately, the herein-disclosed distributed and disaggregated load balancing system supports much higher throughput using fewer physical resources than traditional software-only and hardware-only solutions. Other details and benefits of the disclosed system are discussed with respect to the following features.

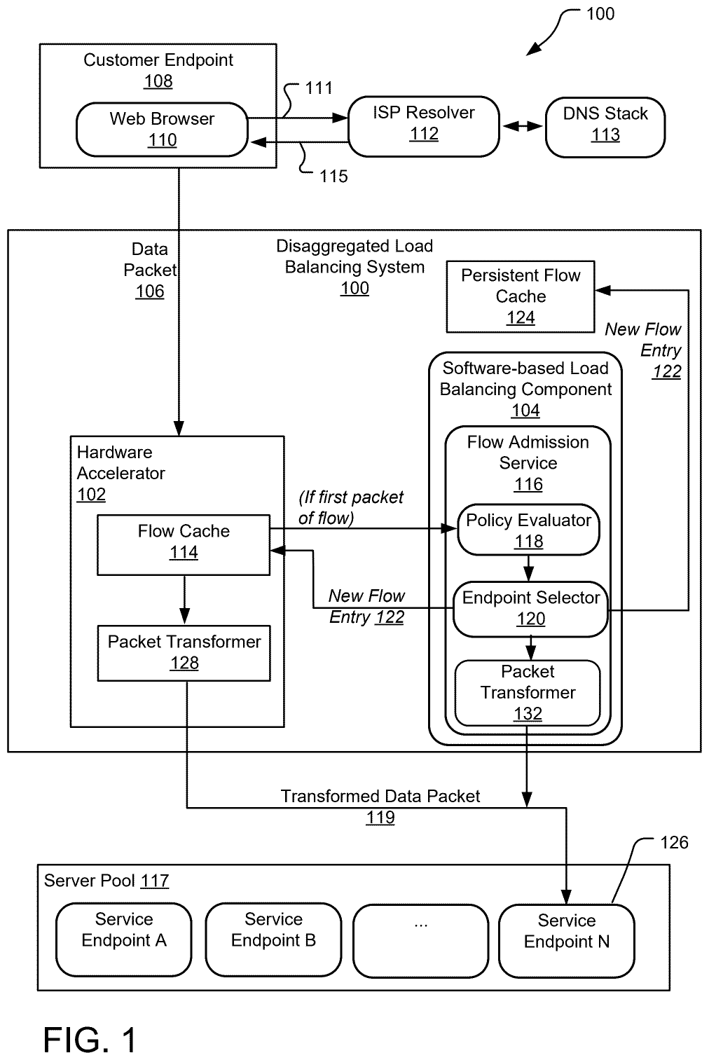

FIG. 1 illustrates an example disaggregated load balancing system 100 implementing aspects the disclosed technology. The disaggregated load balancing system 100 includes a hardware accelerator 102, which is a hardware component specially-purposed to provide routing functionality in support of load balancing systems. In one implementation, the hardware accelerator 102 is a programmable switch ASIC that supports a combination of (fixed) vendor-supplied logic as well as programmable firmware. The programmable firmware executes an abstract application programming interface (API) to communicate with back-end software components of the disaggregated load balancing system 100, including a software-based load balancing component 104. The software-based load balancing component 104 is, in one implementation, a software application executed by a general-purpose server.

Each data packet traversing an end-to-end route through the disaggregated load balancing system 100 is subjected to some processing operations by the hardware accelerator 102 and other processing operations by the software-based load balancing component 104. Specifically, the hardware accelerator 102 is tasked with performing table look-up operations and packet transform operations while the software-based load balancing component 104 is tasked with more memory-intensive operations such as evaluating routing policies to decide how to route each new connection request. These operations for defining new routes are referred to herein as “flow admission operations.”

The example of FIG. 1 illustrates load balancing actions triggered by a user's web-based request (through web browser 110) to visit a target web domain (e.g., a website that is hosted by each one of multiple service endpoints A, B, . . . , N in a server pool 117). The illustrated load balancing actions include flow admission (e.g., defining a new connection between the user's machine and a select server in the server pool 1117) and packet transformation that is performed on a data packet header to direct the data packet to a selected endpoint hosting an instance of the target web domain. In this example, a web browser 110 is shown residing on a customer endpoint 108 (e.g., a user computer), which can be understood as a physical compute device coupled to the disaggregated load balancing system 100 via the internet. The user initiates a new connection request by typing a web address for a target web domain into a window of the web browser 110 (e.g., www.microsoft.com/azure) and hitting the return key. Submission of the connection request triggers a query 111 to an internet service provider (ISP) resolver 112, which is tasked with resolving the target web domain to an internet protocol (IP) address of a server that serves the content of the target web domain. The ISP resolver 112 initiates a recursive domain name server (DNS) lookup in a DNS stack 113.

In the example shown, content of the target web domain is served by each server in a server pool 117 (e.g., servers at the same or different data centers). A domain owner of the target web domain has subscribed to a load balancing service provided by the disaggregated load balancing system 100, and a DNS server in the DNS stack 113 has been configured to direct the traffic in route to the target web domain to an IP address of the hardware accelerator 102. The web browser 110 therefore receives an answer 115 to the query 111 that includes the IP address of the hardware accelerator 102, and the web browser 110 responds by transmitting a data packet 106 to this IP address. In one implementation, the data packet 106 is an SYN packet, which is a type of data packet used to initiates a new transmission control protocol (TCP) connection request.

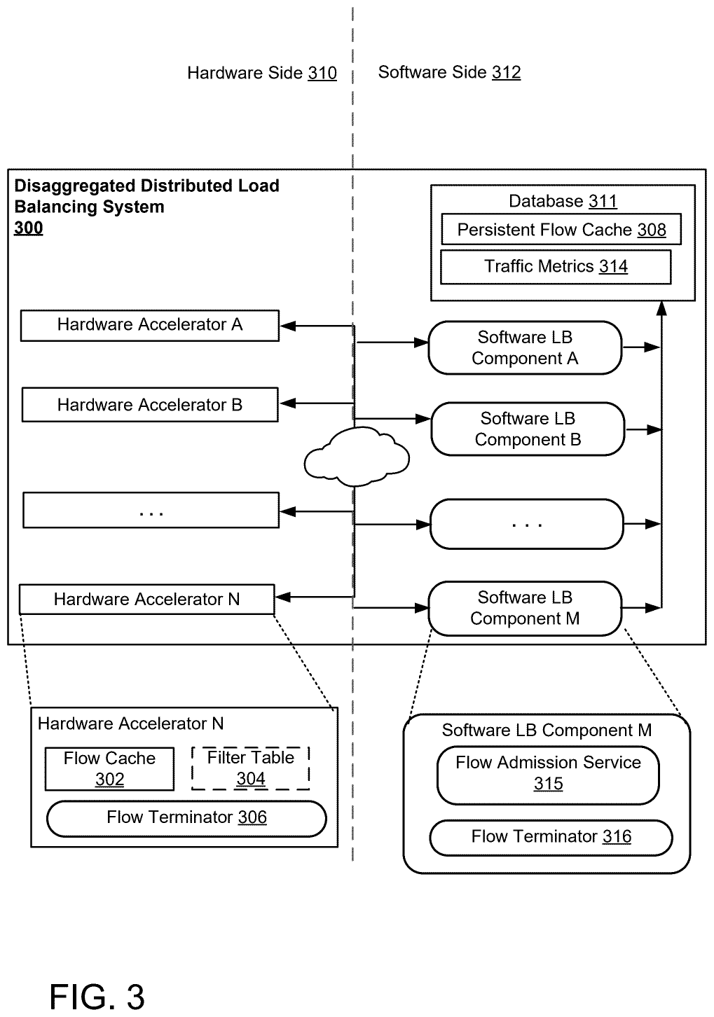

In an implementation where the target web domain is served by servers at many different data centers, each of the different data centers may have one or more instances of the hardware accelerator 102 and the software-based load balancing component 104, such as per the distributed load balancing infrastructure shown and discussed with respect to FIG. 3, below. The multiple instances of the hardware accelerator 102 share the same IP address and cach instance implements vendor-encoded logic to advertise its respective route to the boarder gateway patrol (BGP) network (not shown). When the web browser 110 sends the data packet 106 to the IP address of the hardware accelerator 102, routers of the BGP network direct the data packet 106 to a select instance of the hardware accelerator 102 that can be reached with lowest latency. For example, the data packet 106 is directed to the instance of the hardware accelerator 102 that is physically located at a data center that is in closest geographical proximity to the customer endpoint 108.

Upon receipt of the data packet 106, the hardware accelerator 102 accesses flow cache 114 and performs a flow lookup operation to determine whether the data packet belongs to a previously-defined flow. The flow cache 114 is, in one implementation, a table stored in a memory location that facilitates high-speed retrieval of data describing one or more “flows,” with the term “flow” being consistent with the below definition and descriptions. For example, the flow cache is stored in a volatile memory location such as random-access memory (RAM) or dynamic random access memory (DRAM). As used herein, the term “flow” refers to an established connection defined between two endpoints that is managed by the disaggregated load balancing system 100. Information defining each flow is stored as an entry, referred to herein as a “flow entry,” in a table referred to herein as a flow cache (e.g., the flow cache 114). Each flow entry defines a transformation between header characteristics of an incoming data packet (e.g., the data packet 106) and transformed header information of a corresponding outgoing data packet (e.g., transformed data packet 119). Each flow entry further defines a set of incident data packet header characteristics that, when present, suffice to identify the packet as “belonging to the flow” corresponding to the flow entry. For example, a data packet is determined to belong to a previously-defined flow when its source IP address, source port ID, destination IP address, source port ID, and internet protocol (IP) protocol match that of a flow entry stored in the flow cache 114.

Each flow entry within the flow cache 114 defines a packet header transformation that is to be applied to each packet of the corresponding flow. By example, a packet header transformation in the flow cache 114 may identify the source IP address and port number of each outgoing packet of the flow as well as a destination IP address and port number of a service endpoint (e.g., a service endpoint 126) that has been selected, by the disaggregated load balancing system 100, to receive the flow. By additional example, one or more other packet header transformations in the flow cache 114 transform other aspects of packet handling, such as by subjecting the packet to a rate-limiting rule or dropping the packet entirely (e.g., if it is determined to be from a malicious or otherwise blacklisted source address). In some cases, the flow cache 114 stores additional information about each flow, such as applicable encapsulation addresses and/or a rate-limiting constraint that is to be applied to the flow.

The above-mentioned flow lookup operation entails querying the flow cache 114 based on header information (e.g., source IP and source port and destination IP and destination port) of the data packet 106. In the illustrated scenario where the data packet 106 is the first packet of the associated flow, the lookup operation to the flow cache 114 (performed by the hardware accelerator 102) returns a null result, which signifies that the data packet 106 does not belong to an existing flow.

In the above-described scenario where it is determined that the data packet 106 does not belong to an existing flow, the data packet 106 is transmitted (e.g., off-chip) to a flow admission service 116 executed by the software-based load balancing component 104. The flow admission service 116 includes a policy evaluator 118 that evaluates routing policies applicable to the data packet 106 and an endpoint selector 120 that selects a service endpoint from the server pool 117 based on the routing policies. In one implementation, the policy evaluator 118 identifies applicable routing policies based on an evaluation of the header information within the data packet 106. For example, routing policies are selectively applied based on the source of the data packet 106 and/or the destination of the data packet 106.

Performing flow admission and policy evaluation in the software-based load balancing component 104 (rather than the hardware accelerator 102) affords considerable implementation flexibility and customizability, such as by allowing individual service providers (e.g., the owner or manager of the target web domain) to specify some or all policies to be applied to traffic in-route to endpoint(s) managed by the provider. For example, software-based load balancing component 104 can be programmed by the end user to evaluate and enforce rules that may not be contemplated by the manufacturer/provider of the load balancing system 100. This flexibility is permissible largely due to the vast programmable flexibility of software in general, as well as the significant memory available on the general-purpose server implementing the software-based load balancing component 104 as compared to the hardware accelerator 102 component (e.g., a programmable switch ASIC).

One example of a policy defined by a service provider is a policy for managing data packets arriving from untrusted sources. Different service providers may define different policies of the same type. For example, an untrusted source policy set by one service provider rate-limits connections from untrusted sources while the untrusted source policy of another service provider routes traffic from untrusted sources to a particular endpoint—such as a server that is, for various reasons, more secure than other server(s) in the server pool 117.

Another example of a service-provider-defined-policy is a preferred customer policy that gives preferential treatment to traffic arriving from certain sources. For example, a service provider may want preferred customer traffic to be routed to a group of servers with better performance characteristics (e.g., lower latency or better fault tolerance).

In implementations that support routing policies set by individual service providers, the policy evaluator 118 begins policy evaluation by using the destination IP address of the data packet 106 to identify an applicable set of policies. Once the relevant set of policies is identified, the policy evaluator 118 evaluates potential applicability of each policy in the relevant policy set. For instance, in the above example of the untrusted source policy, policy evaluation entails some analysis of the data packet's source IP address to determine whether the IP address is trusted or untrusted. If so, the policy is determined to apply.

In some implementations, policy evaluation includes selection of a service endpoint (e.g., the endpoint 126 in server pool 117) to service the flow. For example, a given applicable policy may state that all packets headed to the target domain from a specific source IP are to be managed by a particular specified endpoint.

In other implementations, policy evaluation narrows down the pool of selectable service endpoints, such as by defining a subset of servers in the server pool 117 that are eligible to receive the new flow. In still other implementations, policy evaluation dictates parameters such as rate-limiting, but has no influence on the selection of the service endpoint for the flow.

In the above-described scenarios where endpoint selection is not fixed as a consequence of an applicable policy, an endpoint selector 120 is queried to select a service endpoint (e.g., the service endpoint 126) from the server pool 117 to receive the flow. In various implementations, the endpoint selector 120 selects the service endpoint 126 based on different load balancing algorithms and established load-balancing practices, such as by applying a round-robin selection logic, pinging the servers in the server pool 117 to identify a server than can be reached with lowest latency, or hashing data packet header fields of the data packet 106 to select one of the servers in the server pool 117 (e.g., with each different one of the servers being assigned to receive traffic corresponding to a different range of hash values).

In some implementations, the policy evaluator 118 passes selection constraints to the endpoint selector 120 that are used to select the service endpoint. For example, the policy evaluator provides the endpoint selector 120 with an identified subset of the servers in the server pool 117 that have been identified, based on policy evaluation, as being eligible to receive the flow.

Collectively, above-described policy evaluation and service endpoint selection operations define a subset of parameters and/or constraints that the flow admission service 116 uses to define a packet transformation for the data packet 106, which is also to be applied to all subsequent data packets of the same flow. This packet transformation is captured in a new flow entry 122 that is output by the flow admission service 116. The new flow entry 122 is a data structure, such as row that may be added to a cache table, that includes all information needed to transform the data packet 106 and future data packets of the corresponding flow in an identical manner (e.g., to direct the packets to a same service endpoint and otherwise process the packets in the same way, such as by applying a common rate-limiting constraint).

The flow admission service 116 adds the new flow entry 122 to a software- maintained persistent flow cache 124 and also returns the new flow entry 122 to the hardware accelerator 102.

The persistent flow cache 124 can be understood as a non-ephemeral data storage repository that includes all concurrently-active flows of the disaggregated load balancing system 100. If the hardware accelerator 102 loses power, state data stored within the hardware accelerator 102 can be restored from the persistent flow cache 124 without loss of any portion of the flow cache 114. Other potential advantages of the persistent flow cache 124 are discussed with respect to other figures herein.

In response to receipt of the new flow entry 122, the hardware accelerator 102 updates the flow cache 114 to store the new flow entry 122. A packet transformer 132 of the software-based load balancing component 104 then transforms the data packet 106 according to the packet transform defined by the new flow entry. In one implementation, packet transformation entails encapsulating the original packet with an outer header with a source IP address identifying the hardware accelerator 102 and a destination IP address identifying the final endpoint for the packet. The transformation of the data packet 106 yields a transformed data packet 119 that is forwarded, by the packet transformer 132, to a destination IP and destination port corresponding to the selected service endpoint (e.g., the service endpoint 126). In one implementation, the software-based load balancing component 104 performs the above-described packet processing (e.g., flow admission, packet transformation, and packet forwarding) for exclusively the first packet in each new flow. Subsequent packets of each flow are processed in their entirety by the hardware accelerator 102. In another implementation, the software-based load balancing component 104 performs packet processing for a variable number of initial packets of each new flow.

So long as the new flow entry 122 resides in the flow cache 114, cach subsequent data packet of the same flow is processed by the hardware accelerator 102 without action by the software-based load balancing component 104. For example, when the next data packet of the same flow arrives from the customer endpoint 108, the hardware accelerator 102 repeats the above-described cache lookup operation by querying the flow cache 114 with a select combination of header fields extracted from the next data packet. Since the flow cache has been updated to include the new flow entry 122, this cache lookup operation returns a matched flow entry from the flow cache 114, and the packet transformer 128 processes the next data packet according to the packet transform set forth in the matched flow entry.

In some implementations, the hardware accelerator 102 implements flow termination logic to remove flows from the flow cache during a process referred to herein as “eviction.” In one implementation, flow eviction is performed with respect to remove flows that have been explicitly terminated by a flow endpoint (e.g., via inclusion of a flow termination flag) or that have gone inactive for some period of time. This logic ensures that the eviction of each flow entry in the flow cache 114 triggers an eviction of a corresponding flow entry in the persistent flow cache 124. In one implementation, this flow termination logic also ensures that eviction of each flow triggers eviction of a corresponding reverse- direction flow between the same two endpoints while conditioning the evictions upon either (1) both directions of corresponding flows being inactive for period of time or (2) observance of a flow termination flag in either of the forward-direction flow or the corresponding reverse-direction flow. A detailed example of flow termination logic is discussed herein with respect to FIG. 3.

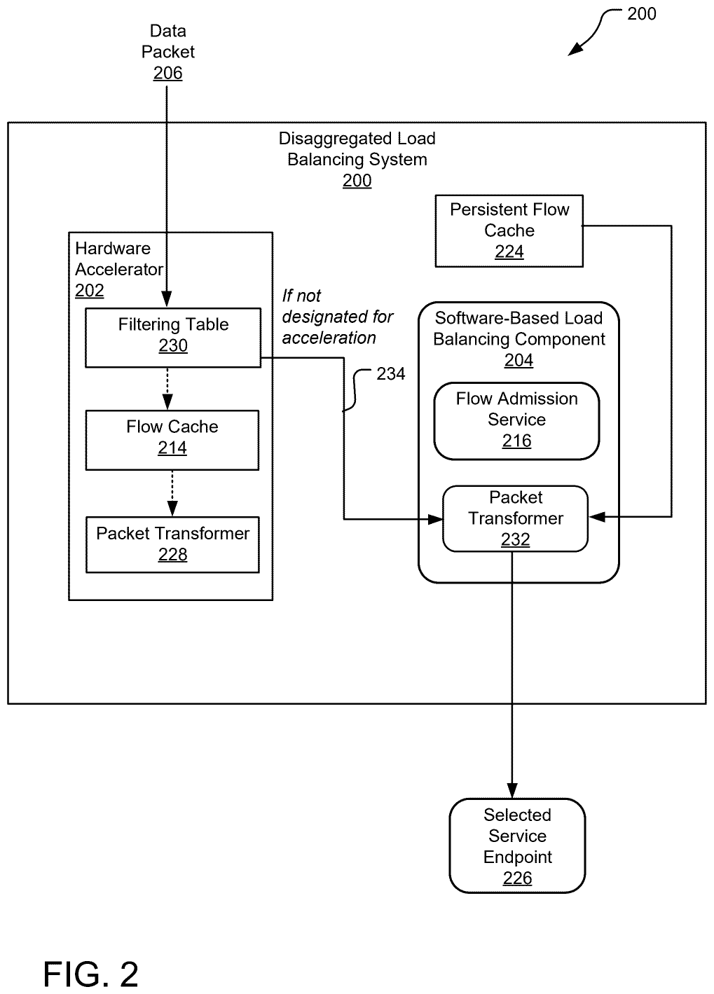

FIG. 2 illustrates aspects of another example disaggregated load balancing system 200. The disaggregated load balancing system 200 includes many components the same or similar to those described with respect to FIG. 1 including a hardware accelerator 202 and a software-based load balancing component 204.

The hardware accelerator 202 is, in one implementation, a programmable switch ASIC that advertises routes to the BGP network and that serves as a “front door” to data packets arriving at the disaggregated load balancing system 200. The hardware accelerator 202 stores a flow cache 214 that tracks concurrently-active flows managed by the disaggregated load balancing system 200 that are being routed through the hardware accelerator 202. Each flow entry in the flow cache 214 defines a packet transformation to be applied to incoming packets of the corresponding flow. The hardware accelerator 202 further includes a packet transformer 228 that processes incoming data packets by applying the corresponding packet transformations defined in the flow cache 214.

When the hardware accelerator 202 receives a data packet 206 that does not correspond to a previously-defined flow residing in the flow cache 214, the hardware accelerator 202 routes the data packet to a flow admission service 216 executed by a software-based load balancing component 204 (e.g., a server). In one implementation, the flow admission service 216 defines each new flow by implementing logic the same or similar to that described above with respect to FIG. 1.

All flows managed by the disaggregated load balancing system 200 are stored in a persistent flow cache 224, which serves as the stateful back-end of the system and is maintained by software (e.g., one or multiple servers).

In addition to providing the same or similar functionality as that discussed above and/or with respect to FIG. 1, the hardware accelerator 202 of FIG. 2 implements logic that allows for selective hardware acceleration of data packets traversing some routes but not others. As used herein, “selective hardware acceleration” refers selective use of the hardware accelerator 202 to perform the packet transformation (e.g., by the packet transformer 228) that is needed to route a data packet of an established flow to its corresponding, designated service endpoint. In FIG. 2, select data packets that are not designated for acceleration are routed to and processed by a packet transformer 232 of the software-based load balancing component 204 instead of a packet transformer 228 of the hardware accelerator 202.

Routes predesignated for selective hardware acceleration are stored in a filtering table 230 on the hardware accelerator 202. Upon receipt of a data packet 206, the hardware accelerator 202 queries the filtering table with header information (e.g., the destination IP and port number) from the data packet 206 to determine whether the data packet 206 is designated for acceleration.

If the query operation to the filtering table 230 returns a null result, the hardware accelerator 202 determines that the route is not predesignated for acceleration and offloads further processing of the data packet 206 to the packet transformer 232 of the software-based load balancing component 204, as shown by path 234. In this case, the data packet 206 is processed entirely by software, including aspects of both flow admission (if applicable for the data packet 206) and packet transformation. To process the data packet 206, the software-based load balancing component 204 first queries the persistent flow cache 224 with header information (e.g., the source IP, source port, destination IP, and destination port) of the data packet 206 to determine whether the data packet 206 belongs to an active, previously-defined flow. If not, the flow admission service 216 defines a new flow as generally described with respect to FIG. 1. Following flow admission or a determination that a matched flow entry exists in the persistent flow cache 224, the packet transformer 232 transforms the data packet 206 (in software) by applying a packet transformation defined by the corresponding matched flow entry. In this scenario, the software-based load balancing component 204 forwards the transformed data packet to a service endpoint 226 identified by the matched flow entry.

In other scenarios where the data packet 206 is designated for acceleration, the query to the filtering table 230 returns a matched route and processing of the data packet 206 continues as generally described with respect to FIG. 1 and as indicated by dotted arrows in FIG. 2. Specifically, the hardware accelerator 202 queries the locally-maintained flow cache 214 to determine whether the data packet 206 belongs to an active, previously-defined flow. If there is no matching flow entry in the flow cache 214, the flow admission service 216 performs flow admission operations to define a new flow entry and the packet transformer 232 of the software-based load balancing component 204 transforms the data packet according to a transformation specified by the new flow and forwards the transformed data packet to the service endpoint 226 identified within the new flow entry. If, on the other hand, the hardware accelerator 202 identifies a matching flow entry in the flow cache 214, flow admission is skipped and the packet transformer 228 of the hardware accelerator 202 transforms a packet header of the data packet 206 according to the packet transform defined by the matching flow entry before forwarding the transformed data packet to the service endpoint 226 identified within the matching flow entry.

The above-described capability to selectively accelerate some flows and not others can advantageously improve overall efficiencies of the disaggregated load balancing system 200 when selectively leveraged in scenarios where the cost of maintaining the flow entry in the flow cache 214 exceeds the gain in throughput that is realized by transforming the data packet by the hardware accelerator 202 rather than by the software-based load balancing component 204. Notably, there exists a measurable storage cost ‘X’ (e.g., in terms of energy expenditure) of adding a flow entry to the flow cache 214 on the hardware accelerator 202 and of storing the flow entry in the flow cache 214 for the duration of the flow. There is likewise a measurable energy expenditure ‘Y1’ associated with an individual packet transform individual packet by the hardware accelerator 202 and a measurable energy expenditure ‘Y2’ associated with performing an identical packet transformation on the software-based load balancing component 204, where Y2 is larger than Y1 because it is more efficient to perform packet transformations on the hardware accelerator 202 than in software. In scenarios where the storage cost X is greater than the net processing savings, Y2−Y1, summed across all data packets of a given flow, it is more costly in terms of power consumption (and consequently, operating costs) to accelerate the flow than to not accelerate the flow.

Examples of flows that are not cost-effective to accelerate in hardware include flows directed to very low bandwidth endpoints as well as flows that can, for various reasons, be pre-identified as having a very low incoming and/or outbound packet rate or a small total number of packets (e.g., below a defined threshold). If, for example, a service endpoint routinely receives an average of 1 packet per hour, there would not be a benefit to processing flows to this endpoint in hardware because the cost of storing the flows in the flow cache 214 of the hardware accelerator would outweigh the power/cost savings that is realized by processing 1 packet per hour in hardware instead of in software. Another example of a type of flow that is not cost-effective to accelerate is a flow that is initiated to perform a DNS lookup. Typically, a DNS lookup request is characterized by transmission of one data packet and one packet received in response.

The filtering table 230 is, in various implementations, populated in different ways. In one implementation, the filtering table 230 is selectively populated with endpoints that are affirmatively identified by service providers subscribed to services of the disaggregating load balancing system 200. For example, a service provider may interact with a web-based portal to the load balancing system 200 to indicate a desire for all traffic inbound to a particular managed IP address to be listed in the filtering table 230 for hardware acceleration and/or for other managed IP addresses to be excluded from hardware acceleration. In another implementation, the filtering table 230 does not explicitly identify accelerated routes but instead stores rules that the hardware accelerator 202 evaluates to whether a particular route is to be accelerated. For example, the service provider of the service endpoint 226 provides the load-balancing system 200 with a rule indicating that acceleration is to be disabled (and not performed) on incoming packets with packet headers that match certain criteria (e.g., identifying a particular combination of source IP address and destination IP address). In still other implementations, the disaggregated load balancing system 200 collects traffic metrics in association with the different service endpoints managed by the system (e.g., the service endpoint 226) and independently modifies and/or manages the filtering table 230 based on recorded traffic statistics (e.g., according to rules defined by the manufacture of the hardware accelerator 202). If, for example, it is observed that a particular service endpoint is experiencing a very low incoming packet rate, the filtering table 230 may be updated to ensure that future packets directed to the particular service endpoint are not accelerated.

Notably, the above-described capability to selectively not accelerate some but not all flows also affords system flexibility due to the fact that advancements in programmable chip technology typically lag behind software. Assume, for example, that a developer chooses to modify the software-based load balancing component 204 to support a new capability, such as a capability to process packets of a new protocol. While it remains possible that a hardware accelerator 202 could be modified to support this new functionality in the future, this hardware innovation likely will lag behind the initial implementation of the functionality in software. Therefore, there exist plausible scenarios where some types of packet transform are supported by the software-based load balancing component 204 but not by the hardware accelerator 202. In these scenarios, the filtering table 230 can be modified to ensure that that packet transformations of these flow are applied by the software-based load balancing component 204 and not the hardware accelerator 202.

In contrast to the above, examples of flows that are cost-efficient to accelerate include those with very high throughput (e.g., on the order of 100 billion bits per second (Gbps)), which is common of flows directed to and from endpoints that provide artificial intelligence (AI) modeling services.

FIG. 3 illustrates an example distributed disaggregated load balancing system 300. The distributed disaggregated load balancing system 300 is similar to the load-balancing systems of FIGS. 1 and 2 but includes a plurality of front-end hardware accelerators (e.g., hardware accelerators A-N) and a plurality of back-end software-based load balancing components (e.g., software LB components A-M) that work together to load balance traffic among server pools supporting each of a plurality of service endpoints (not shown).

The hardware accelerators A-N are shown in FIG. 3 to reside on a hardware side 310 of the distributed disaggregated load balancing system 300, which acts as a front door to all traffic subjected to load balancing performed by the system. In contrast, the software load balancers A-M are shown to reside on a software side 312 of the distributed disaggregated load balancing system 300, which acts as a stateful back-end that supports persistent storage of system-wide flows in a database 311 that stores a persistent flow cache 308 and traffic metrics 314, discussed below.

In one implementation, each of the hardware accelerators A-N is a programmable ASIC switch with a hybrid pipeline design that allows hardware resources of the switch to be split between routing functionality designed by the chip vendor (e.g., route advertisement and layer 3 (L3) routing) and a special-purpose flow processing that is designed by the operator of the distributed disaggregated load balancing system. This hybrid pipeline includes a vendor-side of the chip responsible for routing related to traffic management, for which the programmable ASIC switch is optimized. Additionally, the hybrid pipeline includes a special-purpose processing side of the chip that is configured to evaluate multiple Match-Action tables (e.g., a flow cache 302 or filter table 304) to process and transform data packets. Firmware on the programmable ASIC chip is programmed to support an API that facilities packet transmission between the vendor side and the special-purpose side of the chip. This hybrid pipeline design makes it possible to leverage the capabilities of programmable switch ASICs while also performing custom packet processing at high scale.

Each of the hardware accelerators A-N acts as the front door for traffic directed to a designated set of endpoints, such as service endpoints corresponding to web domains and/or customer endpoints (e.g., for reverse direction traffic leaving the service endpoints). As described with respect to FIG. 1, each of the hardware accelerators A-N communicates with the BGP network to advertise routes to its designated set of service endpoints. Consequently, internet traffic directed to a given service endpoint is received at a corresponding one of the hardware accelerators A-N.

The hardware accelerators A-N cach stores a local flow cache (e.g., the flow cache 302) that is populated with packet transform information pertaining to concurrently- active flows corresponding to the set of endpoints managed by that hardware accelerator. In some implementations, some or all of the hardware accelerators A-N store a filter table (e.g., the filter table 304—shown in dotted lines to indicate optional inclusion) used to selectively designate some flows for acceleration in hardware and others for processing/transformation on the software side 312 of the system. Each of the hardware accelerators A-N is further configured to evaluate its local flow cache and to perform, for each new data packet, processing actions the same or similar to those described with respect to FIG. 1-2. These processing actions include at least: (1) evaluating the local flow cache to determine whether cach newly-received data packet belongs to a previously-defined flow; and (2) transforming the data packets that are determined to belong to previously-defined flows.

Each of the hardware accelerators A-N is configured for selective communication with each one of the back-end software load balancing components (e.g., software load balancers A-M). Collectively, the software LB components A-M collectively serve as a stateful back-end of the system responsible for defining new flows and for maintaining a database 311 storing a persistent flow cache 308 as well as traffic metrics 314 pertaining to traffic observed across all of the hardware accelerators A-N. The database 311 is shown as a single stand-alone box to indicate that the software LB components A-M have mutual access to information within the database 311. This data can, in various implementations, be centrally located or distributed across some or all of the software LB components A-M with the difference instances being synchronized using a suitable cache coherency protocol.

In one implementation, each accelerator utilizes an API that supports selective communications with any of the software LB components A-M and likewise the software LB components A-M utilize the API to selectively communicate with any of the hardware accelerators A-N. Communications between the hardware accelerators A-N and the software LB components A-M are achieved using a tunnel protocol that allows the respective pairs of hardware accelerators and software accelerators managing traffic of each different flow to be located anywhere within a network, including at different data centers.

Notably, the relationship between the hardware accelerators A-N and software LB components A-M is not 1-to-1. When a given hardware accelerator receives a data packet and determines, based on a look-up to its local flow cache, that the data packet does not belong to an existing flow, the hardware accelerator dynamically selects a corresponding one of the software LB components A-M to receive the data packet and perform flow admission (e.g., by a flow admission service 315 executing on the respective one of the software LB components). This forwarding decision can, in various implementations, be based on different logic. In one implementation, the hardware accelerators apply a hash to some portion of a data packet's header information (e.g., source IP and/or destination IP) and, based on the result of the hash, select a software load balancer to perform flow admission for the associated data packet. Notably, flow admission is performed bi-directionally and it is not required for forward direction packets of a given flow to be directed through the same hardware accelerator as the corresponding reverse-direction packets of a given flow.

Since each of the hardware accelerators can selectively direct a given data packet to any of the software load balancers, and vice versa, the hardware side 310 of the distributed disaggregated load balancing system 300 can be scaled independent of the software side 312.

The individual software load balancers A-M are, in one implementation, each configured to execute logic serving the functions generally described with respect to FIG. 1 including policy evaluation and endpoint selection. Each newly-defined flow is added to the persistent flow cache 308, which is mutually accessible to all of the software LB components A-M and also accessible, via suitable API call, to the hardware load balancers A-N. In this sense, the persistent flow cache 308 stores flow information for all flows managed across the entire system. In contrast, the flow cache that is local to each individual one of the hardware accelerators A-N stores flow information for the subset of system flows that are directed through that respective hardware accelerator.

Functionality of the persistent flow cache 308 is two-fold. First, the persistent flow cache 308 is usable to restore any of the hardware-based flow caches (e.g., the flow cache 302) in the system. Thus, the hardware accelerators can operate ephemerally and system data is not lost if/when a hardware accelerator goes offline. Second, the persistent flow cache 308 makes it possible to implement an effective system-wide cache eviction protocol that ensures efficient and bi-directional clean-up synchronization across the flow caches stored locally in the different hardware accelerators.

Notably, cach flow managed within the system of FIG. 3 is direction-specific, meaning that each forward-direction flow has a corresponding reverse direction flow that is also represented as a separate flow entry in the persistent flow cache 308. In some implementations, a corresponding pair of forward-direction/reverse-direction flows can be routed through different hardware accelerators and thus have corresponding flow entries within flow caches local to different pairs of the hardware accelerators. The system 300 implements an efficient, low-overhead eviction protocol that ensures eviction of a flow pair (e.g., a forward-direction flow and the corresponding reverse-direction flow) from all system caches (e.g., the persistent flow cache 308 and the flow cache 302 of each hardware accelerator) during each different eviction operation.

The disclosed eviction protocol also implements logic ensuring that a given pair of corresponding forward-direction and reverse-direction flows are not evicted unless both flows are inactive for a threshold period of time. Notably, there exist scenarios where a forward-direction flow is inactive while the corresponding reverse-direction flow remains active. In these scenarios, it is desirable to keep both directional flows alive (meaning defined within the persistent flow cache 308) until an explicit termination flag is set or until both flows go inactive for a long enough to trigger implicit eviction in both directions. These objectives are achieved via the logic described below.

In the implementation of FIG. 3, each of the hardware accelerators includes a flow terminator 306 (e.g., firmware) that takes quick action at flow termination to evict a flow from its local cache and to notify the software side 312 of the system of the eviction. Flow eviction can occur in response to two types of trigger event: (1) an explicit flow termination and (2) an implicit flow termination. Explicit flow termination occurs when the source endpoint includes a flow termination flag in a data packet to indicate that the data packet is the last packet of the given flow, as is common in data packets formatted according to Transmission Control Protocol (TCP). In contrast, an implicit flow termination occurs when a forward-direction flow and the corresponding reverse-direction flow between the same pair of endpoints both go inactive for a threshold period of time. For example, implicit flow termination may be performed when no packet is received in either direction for a set period of time, such as a minute, 5 minutes, or other interval of predefined length.

When the flow terminator 306 of a given hardware accelerator determines that a flow has been explicitly terminated, the hardware accelerator deletes the corresponding flow entry from its local flow cache (e.g., the flow cache 302) and transmits an explicit eviction notification to a flow terminator 316 on the software side 312 of the system. In one implementation, an instance of the flow terminator 316 is executed on each different one of the software LB components A-M.

The explicit eviction notification received at the flow terminator 316 identifies the corresponding flow that included the explicit termination flag. Receipt of this notification triggers an eviction sequence performed by the flow terminator 316. A first operation in the eviction sequence includes a flow entry in the persistent flow cache 308 that corresponds to the explicitly-terminated flow as well as the flow entry representing the corresponding reverse-direction flow between the same endpoints. A second operation in the eviction sequence includes identifying, from information stored in the database 311, a select one of the hardware accelerators A-N responsible for managing the reverse-direction flow and sending an eviction instruction to the select hardware accelerator. The eviction instruction instructs the select hardware accelerator to remove of the reverse-direction flow from its local flow cache. A third operation in the eviction sequence includes deletes both the forward-direction and reverse-direction flow entries from the persistent flow cache 308.

In contract to explicit termination, implicit termination determinations are performed by the software side 312 of the system based on the traffic metrics 314 that are tracked and persistently stored in association with each flow in the persistent flow cache 308.

In one implementation, each the hardware accelerators A-N is configured to send traffic metrics to component(s) on the software side 312 in response to the processing and forwarding of each different data packet. For example, when the hardware accelerator A transforms a data packet and forwards the data packet to a service endpoint, the hardware accelerator A also transmits a packet notification to the software side 312 of the system that identifies the flow and that includes a timestamp of the transmitted data packet. The software side 312 of the system uses these received packet notifications to update the traffic metrics 314, which may include metrics for each flow such as packet frequency, time-of-last-received-packet, total number of packets transmitted in the flow, latency statistics, and more.

Using the traffic metrics 314, the flow terminator 316 in each of the software LB components A-M is capable of determining how much time has elapsed since the last packet was received with respect to each different flow stored in the persistent flow cache 308. In one implementation, the flow terminator 316 deploys one or more agents to monitor the traffic metrics 314 and to generate an implicit eviction notification when a threshold period of time has elapsed since receipt of a most recent packet in either direction of a flow pair, where the flow pair consists of (1) a forward-direction flow and (2) the corresponding reverse direction flow associated with the same pair of endpoints. When the flow terminator 316 detects generation of the implicit eviction notification, the flow terminator 316 evicts flow entries corresponding to the flow pair from the persistent flow cache 308 and also instructs the respective hardware accelerator(s) managing the flow(s) to remove the corresponding flow entries from their respective local flow caches (e.g., instances of the flow cache 302).

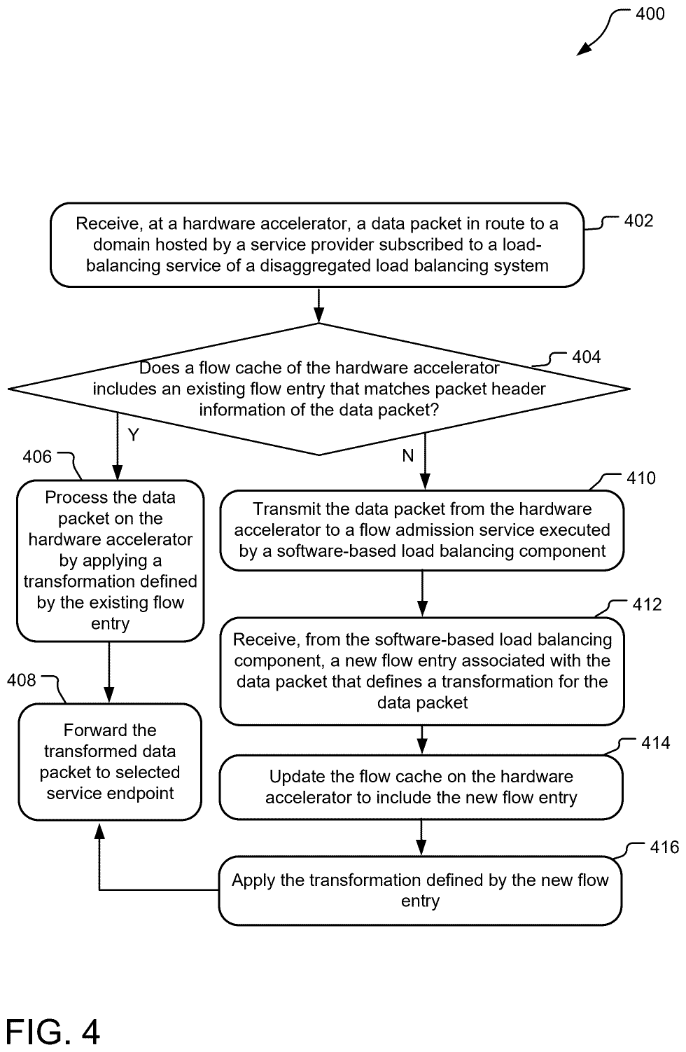

FIG. 4 illustrates example operations 400 for performing packet transformations used to route data packets within a disaggregated load balancing system. A receiving operation 402 receives, at a hardware accelerator, a data packet in route to a domain hosted by a service provider subscribed to a load-balancing service of the disaggregated load balancing system. A determination operation 404 determines whether a flow cache of the hardware accelerator includes an existing flow entry that matches packet header information of the data packet. For example, execution of the determination operation 404 may including searching for flow entries in the flow cache characterized by the same source IP address, source port, destination IP address, destination port, and IP protocol as the data packet.

If the determination operation 404 results in identification of an existing flow entry in the flow cache that matches the packet header information, a processing operation 406 processes the data packet on the hardware accelerator by applying a transformation defined by the existing flow entry. When applied to the data packet, the transformation updates a destination address of the data packet to correspond to a selected service endpoint identified by the flow entry. A forwarding operation 408 forwards the transformed packet to the select service endpoint.

If the determination operation 404 does not result in identification of an existing flow entry in the flow cache that matches the packet header information, a transmission operation 410 transmits the data packet to a flow admission service executed by a software-based load balancing component. The flow admission service selects a service endpoint to receive the data packet.

A receiving operation 412 receives, from the software-based load balancing component, a new flow entry associated with the data packet. The new flow entry defines a transformation that, when applied to the data packet, updates a destination address of the data packet to correspond to the selected service endpoint.

A cache update operation 414 updates the flow cache of the hardware accelerator to include the new flow entry, and a processing operation 416 processes the data packet by applying the transformation defined by the new flow entry. In one implementation, the processing operation 416 on the data packet (e.g., the first packet of a new flow) is applied by the software-based load balancing component while subsequent packets of the same flow (e.g., all packets except for the first packet of the flow) are processed by the processing operation 406 of the hardware accelerator, as described above. Following packet transformation, the forwarding operation 408 forwards the transformed packet to the selected service endpoint.

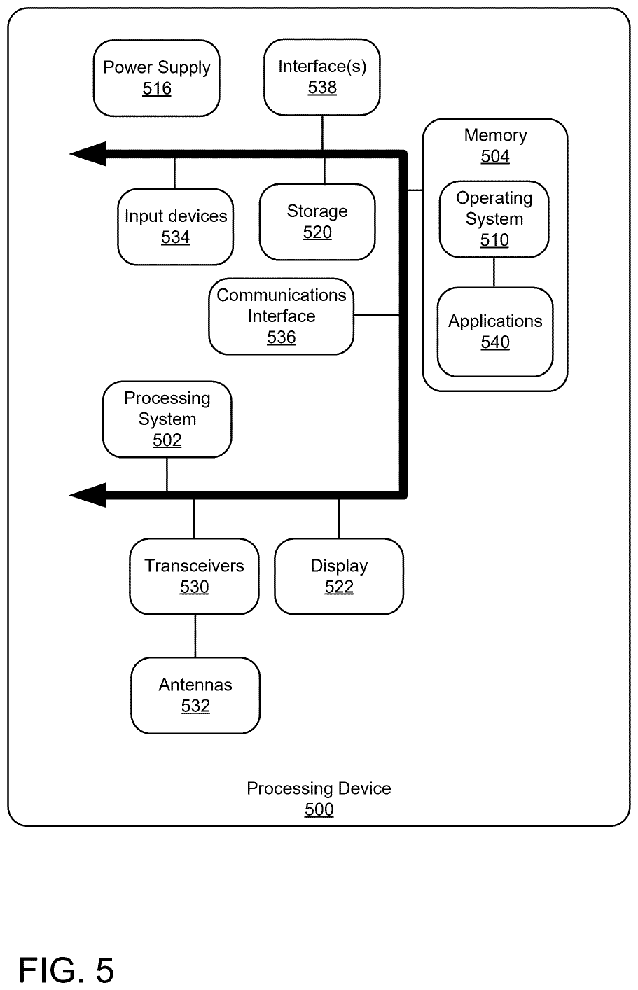

FIG. 5 illustrates an example schematic of a processing device 500 suitable for implementing aspects of the disclosed technology. The processing device 500 includes a processing system 502, memory 504, a display 522, and other interfaces 538 (e.g., buttons). The processing system 502 may each one or more computer processing units (CPUs), graphics processing units (GPUs), etc.

The memory 504 generally includes both volatile memory (e.g., random access memory (RAM)) and non-volatile memory (e.g., flash memory). An operating system 510 resides in the memory 504 and is executed by the processing system 502. One or more applications 540 (e.g., the flow admission service 116 of FIG. 1, packet transformer 232 of FIG. 2, or flow terminator 316 of FIG. 3) are loaded in the memory 504 and executed on the operating system 510 by the processing system 502. In some implementations, aspects of the flow admission service of FIG. 1 are loaded into memory of different processing devices connected across a network. The applications 540 may receive inputs from one another as well as from various input local devices 534 such as a microphone, input accessory (e.g., keypad, mouse, stylus, touchpad, gamepad, racing wheel, joystick), or a camera.

Additionally, the applications 540 may receive input from one or more remote devices, such as remotely-located servers or smart devices, by communicating with such devices over a wired or wireless network using more communication transceivers 530 and an antenna 432 to provide network connectivity (e.g., a mobile phone network, Wi-Fi®, Bluetooth®). The processing device 500 may also include one or more storage devices 520 (e.g., non-volatile storage). Other configurations may also be employed. In one implementation, the significant cohort identifier 217 of FIG. 2 is an application executing on the processing device 500 or as a distributed application with different components executing on many different devices. The significant cohort identifier connects to a centralized telemetry storage repository over a network that stores telemetry data from many different devices.

The processing device 500 further includes a power supply 516, which is powered by one or more batteries or other power sources and which provides power to other components of the processing device 500. The power supply 516 may also be connected to an external power source (not shown) that overrides or recharges the built-in batteries or other power sources.

The processing device 500 may include a variety of tangible computer-readable storage media and intangible computer-readable communication signals. Tangible computer-readable storage can be embodied by any available media that can be accessed by the processing device 500 and includes both volatile and nonvolatile storage media, removable and non-removable storage media. Tangible computer-readable storage media excludes intangible and transitory communications signals and includes volatile and nonvolatile, removable, and non-removable storage media implemented in any method or technology for storage of information such as computer readable instructions, data structures, program modules or other data. Tangible computer-readable storage media includes RAM, read-only memory (ROM), electrically crasable programmable read-only memory (EEPROM), flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the processing device 500. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, intangible communication signals include wired media such as a wired network or direct-wired connection, and wireless media such as acoustic, radio frequency (RF), infrared and other wireless media.

Some implementations may comprise an article of manufacture. An article of manufacture may comprise a tangible storage medium (a memory device) to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled and/or interpreted programming language.

In some aspects, the techniques described herein relate to a method including: receiving, at a hardware accelerator, a data packet in route to a domain hosted by a service provider subscribed to a load-balancing service; performing a lookup operation in a flow cache stored on the hardware accelerator based on packet header information of the data packet; in response to determining that the flow cache of the hardware accelerator does not include a flow entry that matches the packet header information of the data packet, transmitting the data packet from the hardware accelerator to a flow admission service executed by a software-based load balancing component; receiving, from the software-based load balancing component, a new flow entry associated with the data packet that defines a first packet transformation for the data packet; updating the flow cache stored on the hardware accelerator to include the new flow entry; and in response to determining that a subsequently-received data packet matches the packet header information of the new flow entry, processing the subsequently-received the data packet on the hardware accelerator and according to the first packet transformation.

In some aspects, the techniques described herein relate to a method, further including: evaluating, by the flow admission service, one or more policies to determine the first packet transformation; defining, by the flow admission service, the new flow entry that defines the first packet transformation; and processing the data packet on the software-based load balancing component according to the first packet transformation.

In some aspects, the techniques described herein relate to a method, further including: identifying, by the software-based load balancing component, one or more relevant packet transform policies based on the packet header information; selecting, from a pool of servers configured to serve content of the domain, a service endpoint to receive the transformed data packet; defining the first packet transformation based on evaluation of the one or more relevant packet transform policies and the service endpoint; and transmitting, from the software-based load balancing component, the new flow entry to the hardware accelerator.

In some aspects, the techniques described herein relate to a method, wherein the load-balancing service is part of a disaggregated load balancing system that further includes multiple instances of the software-based load balancing component and the method further includes: selecting an instance of the software-based load balancing component to perform flow admission for the data packet based on the packet header information of the data packet.

In some aspects, the techniques described herein relate to a method, wherein the load-balancing service is part of a disaggregated load balancing system that further includes: multiple instances of the hardware accelerator that each locally maintain a flow cache; and multiple instances of the software-based load balancing component each configured to communicate with and perform flow admission operations for data packets received by the multiple instances of the hardware accelerator.

In some aspects, the techniques described herein relate to a method, wherein data stored within the flow cache of each of the multiple instances of the hardware accelerator is stored in a persistent flow cache accessible to the multiple instances of the software-based load balancing component.

In some aspects, the techniques described herein relate to a method, wherein the multiple instances of the hardware accelerator utilize a tunneling protocol to communicate with the multiple instances of the software-based load balancing component.

In some aspects, the techniques described herein relate to a method, further including: detecting, by the hardware accelerator, a flow termination flag in the data packet; in response to detection of the flow termination flag, evicting the flow entry from the flow cache of the hardware accelerator and transmitting an eviction notification to the software- based load balancer; in response to receipt of the eviction notification, deleting the flow entry and a corresponding reverse-direction flow entry from a persistent flow cache.

In some aspects, the techniques described herein relate to a method, further including: performing, by the hardware accelerator, a filtering table lookup operation based on data packet header information to determine whether a target endpoint of the data packet has been predesignated for acceleration; and in response to determining that the target endpoint has not been predesignated for acceleration, transmitting the data packet to the software-based load balancing component for a packet transformation operation.

In some aspects, the techniques described herein relate to a disaggregated load balancing system configured to perform load balancing among a pool of servers configured to serve content of a domain, the disaggregated load balancing system including: a hardware accelerator configured to: access a local flow cache to determine whether a data packet in route to a domain belongs to a previously-defined flow or a new flow; in response to determining that a data packet belongs to a new flow not yet defined within the local flow cache, forward the data packet off-chip to a flow admission service executed by a server; and in response to determining that the data packet belongs to an existing flow with a corresponding flow entry within the local flow cache, generate a transformed data packet by transforming the data packet according to a transformation defined within the corresponding flow entry.

In some aspects, the techniques described herein relate to a disaggregated load balancing system, further including: a software-based load balancing component that executes the flow admission service and is configured to: determine the transformation to be applied to the data packet and other data packets of a same flow; and transmit a new flow entry to the hardware accelerator for storage in the local flow cache, the new flow entry identifying the transformation.

In some aspects, the techniques described herein relate to a disaggregated load balancing system, wherein the software-based load balancing component is further configured to: identify one or more relevant packet transform policies based on packet header information of the data packet; selecting, from the pool of servers, a service endpoint to receive the transformed data packet; and define the transformation based on evaluation of the one or more relevant packet transform policies and the service endpoint.

In some aspects, the techniques described herein relate to a disaggregated load balancing system, further including: multiple instances of the hardware accelerator that each locally maintain a flow cache; and multiple instances of the software-based load balancing component each configured to communicate with and perform flow admission operations for data packets received by the multiple instances of the hardware accelerator.

In some aspects, the techniques described herein relate to a disaggregated load balancing system, wherein data stored within the flow cache of each of the multiple instances of the hardware accelerator is stored in a persistent flow cache accessible to the multiple instances of the software-based load balancing component.

In some aspects, the techniques described herein relate to a disaggregated load balancing system, wherein the multiple instances of the hardware accelerator utilize a tunneling protocol to communicate with the multiple instances of the software-based load balancing component.

In some aspects, the techniques described herein relate to a disaggregated load balancing system, wherein the multiple instances of the hardware accelerator are each configured to transmit traffic metrics to a database accessible to the multiple instances of the software-based load balancing component and wherein the traffic metrics are utilized to enforce an eviction protocol that selectively evicts flows from corresponding locations within the persistent flow cache and the local flow cache of the hardware accelerator.

In some aspects, the techniques described herein relate to a tangible computer-readable storage media encoding processor-executable instructions for executing a computer process for load balancing among a pool of servers configured to serve content of a domain including: receiving, at a hardware accelerator, a data packet in route to the domain; in response to determining that a flow cache stored on the hardware accelerator does not yet include a flow entry that matches packet header information of the data packet, transmitting the data packet from the hardware accelerator to a flow admission service executed by a software-based load balancing component; receiving, at the hardware accelerator and from the software-based load balancing component, a new flow entry associated with the data packet that defines a first packet transformation for the data packet; updating the flow cache stored on the hardware accelerator to include the new flow entry; and in response to determining that a subsequently-received data packet matches the packet header information of the new flow entry, processing the subsequently-received the data packet on the hardware accelerator and according to the first packet transformation.

In some aspects, the techniques described herein relate to a tangible computer-readable storage media, wherein the computer process further includes: evaluating, by the flow admission service, one or more policies to determine the first packet transformation; defining, by the flow admission service, the new flow entry; and processing the data packet on the software-based load balancing component according to the first packet transformation.

In some aspects, the techniques described herein relate to a tangible computer-readable storage media, further including: identifying, by the software-based load balancing component, one or more relevant packet transform policies based on the packet header information; selecting, from the pool of servers, a service endpoint to receive the transformed data packet; defining the first packet transformation based on evaluation of the one or more relevant packet transform policies and the service endpoint; and transmitting, from the software-based load balancing component, the new flow entry to the hardware accelerator.

In some aspects, the techniques described herein relate to a tangible computer-readable storage media, wherein the computer process further includes: selecting one of multiple instances of the software-based load balancing component to perform flow admission for the data packet based on the packet header information of the data packet.

The logical operations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of exemplary implementations.

What is claimed is:

1. A method comprising:
receiving, at a hardware accelerator, a data packet in route to a domain hosted by a service provider subscribed to a load-balancing service;
performing a lookup operation in a flow cache stored on the hardware accelerator based on packet header information of the data packet;
in response to determining that the flow cache of the hardware accelerator does not include a flow entry that matches the packet header information of the data packet, transmitting the data packet from the hardware accelerator to a flow admission service executed by a software-based load balancing component;
receiving, from the software-based load balancing component, a new flow entry associated with the data packet that defines a first packet transformation for the data packet;
updating the flow cache stored on the hardware accelerator to include the new flow entry; and
in response to determining that a subsequently-received data packet matches the packet header information of the new flow entry, processing the subsequently-received the data packet on the hardware accelerator and according to the first packet transformation.

2. The method of claim 1, further comprising:
evaluating, by the flow admission service, one or more policies to determine the first packet transformation;
defining, by the flow admission service, the new flow entry that defines the first packet transformation; and
processing the data packet on the software-based load balancing component according to the first packet transformation.

3. The method of claim 2, further comprising:
identifying, by the software-based load balancing component, one or more relevant packet transform policies based on the packet header information;
selecting, from a pool of servers configured to serve content of the domain, a service endpoint to receive the transformed data packet;
defining the first packet transformation based on evaluation of the one or more relevant packet transform policies and the service endpoint; and
transmitting, from the software-based load balancing component, the new flow entry to the hardware accelerator.

4. The method of claim 1, wherein the load-balancing service is part of a disaggregated load balancing system that further includes multiple instances of the software-based load balancing component and the method further includes:
selecting an instance of the software-based load balancing component to perform flow admission for the data packet based on the packet header information of the data packet.

5. The method of claim 1, wherein the load-balancing service is part of a disaggregated load balancing system that further includes:
multiple instances of the hardware accelerator that each locally maintain a flow cache; and
multiple instances of the software-based load balancing component each configured to communicate with and perform flow admission operations for data packets received by the multiple instances of the hardware accelerator.

6. The method of claim 5, wherein data stored within the flow cache of each of the multiple instances of the hardware accelerator is stored in a persistent flow cache accessible to the multiple instances of the software-based load balancing component.

7. The method of claim 5, wherein the multiple instances of the hardware accelerator utilize a tunneling protocol to communicate with the multiple instances of the software-based load balancing component.

8. The method of claim 1, further comprising:
detecting, by the hardware accelerator, a flow termination flag in the data packet;
in response to detection of the flow termination flag, evicting the flow entry from the flow cache of the hardware accelerator and transmitting an eviction notification to the software-based load balancer;
in response to receipt of the eviction notification, deleting the flow entry and a corresponding reverse-direction flow entry from a persistent flow cache.

9. The method of claim 1, further comprising:
performing, by the hardware accelerator, a filtering table lookup operation based on data packet header information to determine whether a target endpoint of the data packet has been predesignated for acceleration; and
in response to determining that the target endpoint has not been predesignated for acceleration, transmitting the data packet to the software-based load balancing component for a packet transformation operation.

10. A disaggregated load balancing system configured to perform load balancing among a pool of servers configured to serve content of a domain, the disaggregated load balancing system comprising:
a hardware accelerator configured to:
access a local flow cache to determine whether a data packet in route to a domain belongs to a previously-defined flow or a new flow;
in response to determining that a data packet belongs to a new flow not yet defined within the local flow cache, forward the data packet off-chip to a flow admission service executed by a server; and
in response to determining that the data packet belongs to an existing flow with a corresponding flow entry within the local flow cache, generate a transformed data packet by transforming the data packet according to a transformation defined within the corresponding flow entry.

11. The disaggregated load balancing system of claim 10, further comprising:
a software-based load balancing component that executes the flow admission service and is configured to:
determine the transformation to be applied to the data packet and other data packets of a same flow; and
transmit a new flow entry to the hardware accelerator for storage in the local flow cache, the new flow entry identifying the transformation.

12. The disaggregated load balancing system of claim 11, wherein the software-based load balancing component is further configured to:
identify one or more relevant packet transform policies based on packet header information of the data packet;
selecting, from the pool of servers, a service endpoint to receive the transformed data packet; and
define the transformation based on evaluation of the one or more relevant packet transform policies and the service endpoint.

13. The disaggregated load balancing system of claim 11, further comprising:
multiple instances of the hardware accelerator that each locally maintain a flow cache; and
multiple instances of the software-based load balancing component each configured to communicate with and perform flow admission operations for data packets received by the multiple instances of the hardware accelerator.

14. The disaggregated load balancing system of claim 13, wherein data stored within the flow cache of each of the multiple instances of the hardware accelerator is stored in a persistent flow cache accessible to the multiple instances of the software-based load balancing component.

15. The disaggregated load balancing system of claim 13, wherein the multiple instances of the hardware accelerator utilize a tunneling protocol to communicate with the multiple instances of the software-based load balancing component.

16. The disaggregated load balancing system of claim 14, wherein the multiple instances of the hardware accelerator are each configured to transmit traffic metrics to a database accessible to the multiple instances of the software-based load balancing component and wherein the traffic metrics are utilized to enforce an eviction protocol that selectively evicts flows from corresponding locations within the persistent flow cache and the local flow cache of the hardware accelerator.

17. A tangible computer-readable storage media encoding processor-executable instructions for executing a computer process for load balancing among a pool of servers configured to serve content of a domain comprising:
receiving, at a hardware accelerator, a data packet in route to the domain;
in response to determining that a flow cache stored on the hardware accelerator does not yet include a flow entry that matches packet header information of the data packet, transmitting the data packet from the hardware accelerator to a flow admission service executed by a software-based load balancing component;
receiving, at the hardware accelerator and from the software-based load balancing component, a new flow entry associated with the data packet that defines a first packet transformation for the data packet;
updating the flow cache stored on the hardware accelerator to include the new flow entry; and
in response to determining that a subsequently-received data packet matches the packet header information of the new flow entry, processing the subsequently-received the data packet on the hardware accelerator and according to the first packet transformation.

18. The tangible computer-readable storage media of claim 17, wherein the computer process further comprises:
evaluating, by the flow admission service, one or more policies to determine the first packet transformation;
defining, by the flow admission service, the new flow entry; and
processing the data packet on the software-based load balancing component according to the first packet transformation.

19. The tangible computer-readable storage media of claim 18, further comprising:
identifying, by the software-based load balancing component, one or more relevant packet transform policies based on the packet header information;
selecting, from the pool of servers, a service endpoint to receive the transformed data packet;
defining the first packet transformation based on evaluation of the one or more relevant packet transform policies and the service endpoint; and
transmitting, from the software-based load balancing component, the new flow entry to the hardware accelerator.

20. The tangible computer-readable storage media of claim 17, wherein the computer process further comprises:
selecting one of multiple instances of the software-based load balancing component to perform flow admission for the data packet based on the packet header information of the data packet.
